(19) United States
(12) Patent Application Publication
(10) Pub. No.: US 2009/0310207 A1
(43) Pub. Date: Dec. 17, 2009

(54) Polarization Controller with Minimum Wavelength Dependency

(75) Inventor: Ruediger Maestle, Boeblingen (DE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Palo Alto, CA (US)

(21) Appl. No.: 12/064,380

(22) PCT Filed: Nov. 16, 2001
(86) PCT No.: PCT/EP05/56021

§ 371 Date: Aug. 1, 2008

(30) Foreign Application Priority Data
Aug. 26, 2005 (EP) PCT/EP2005/054222

(51) Int. Cl. G02F 1/01

(52) U.S. Cl. 359/249

(57) ABSTRACT

The invention relates to converting a first light signal (L1) into a second light signal (L2) polarized according to a set of different states of polarization, whereby the set of different polarization states is represented by a corresponding set, of Stokes vectors in a Stokes space representation, and wherein the end points of the set of Stokes vectors span a geometric shape, wherein, in response to a desired geometric shape with an arbitrary orientation in the Stokes space, a setting (C1, C2) of at least two adjustable optical elements (22, 23) arranged in an optical path between an optical input (201) and an optical output (202) is determined such that, while varying the wavelength of the input signal (L1) within a certain range, corresponding variations of the geometric shape are below a desired value.

### BACKGROUND ART

The present invention relates to generating optical signals with defined polarization states.

For determining optical properties of an optical device under test (DUT), a set of probing signals with defined polarization states is commonly used. Such polarization states might be generated by means of a polarization controller, such as the Agilent 8169A Polarization Controller. This polarization controller allows for providing probe signals at precisely synthesized states of polarization. The response signals returning from the DUT allows for determining optical properties of a DUT. Information about the Agilent 8169A Polarization Controller can be drawn from the technical specifications available at Product or Service Web Pages of Agilent Technologies Inc. or from the patent application US 2004/0067062 A1 of the same applicant.

Different methods are known for determining optical properties the DUT. According to the so-called Mueller Method, probing signals at four precisely synthesized, e.g. tetragonal, states of polarization are provided to the DUT and the power of the optical signals returning from the DUT are detected. From the known input states of polarization and the measured signal powers, the elements of so-called Mueller are determined. From elements of this Matrix, optical properties of the DUT, e.g. the minimum and maximum insertion loss, polarization dependent loss (PDL), the group delay (GD) or the differential group delay (DGD) can be derived.

Alternatively the so called Jones matrix method is known, wherein the optical properties are derived by measuring the output states of polarization of the signals returning from the DUT for at least two, preferably orthogonal states of polarization in a further alternative a variant of the Mueller method might be applied by applying a set of six, preferably orthogonal states of polarization.

### DISCLOSURE

It is an object of the invention to provide an improved generating of optical signals with defined polarization states. The object is solved by the independent claims. Further embodiments are shown by the dependent claims.

Each state of polarization (SOP) of the polarization controller can be regarded as a vector in a Stokes space. The endpoints of these vectors, further also referred to as SOP system, span a geometric shape. Depending on the number of endpoints, the geometric shape is a line (two endpoints), a triangle (3 endpoints) or a polyhedron (more that three endpoints).

For the important case of four states of polarization used for the above-mentioned Mueller Method, the polyhedron is a tetrahedron comprising four triangular faces that are not necessarily equal. A regular tetrahedron is a tetrahedron of four equal triangular faces.

One problem of polarisation controller used for a wide range of wavelengths is that while changing the wavelength of an input signal of the polarisation controller, the SOP system will not remain constant. Depending on the settings of the polarization controller, the changes of the SOP system over a regarded wavelength range may be significantly high.

The invention is based on the insight that the absolute change of an SOP system within the Stokes space is often not of any significance, as long as the geometric shape does not significantly change, i.e. variations of the relative orientations of the Stokes vectors to each other do not significantly change. To the contrary, significant changes of the geometric shape, e.g. a relative volume change of a regular tetrahedron spanned by four tetragonal SOP's of more than +/−5%, are often unacceptable.

According to embodiments of the inventions, in response to a desired geometric shape with an arbitrary orientation in the Stokes space, a setting of adjustable optical elements, arranged in an optical path between an optical input and an optical output of a polarization controller, are determined such that, while varying the wavelength of an input signal within a certain range, corresponding variations of the shape of the polyhedron are kept small. In other words, such variations shall mainly results in a rotation of the shape.

Therewith the invention allows keeping the settings fix when performing wavelength sweeps without varying the respective settings, e.g. the angular position of a quarter wave plate and a half wave plate in dependence on the wavelength of the incident light, or without performing additional measurements of the output SOP's at different wavelengths.

In an embodiment, a merit function representing the difference between the desired shape and the shape resulting from a setting over the wavelength range is defined. Generally, a merit function is a function that measures the agreement between data and the fitting model for a particular choice of the parameters. By convention, the merit function is small when the agreement is good. Therefore, a plurality of settings is determined and the merit functions of the different settings are determined. Then, a setting out of the plurality of settings is selected that shows the minimum merit function.

In an alternative embodiment, the plurality of settings is determined by an iteration process. This process might start with a first setting showing the desired polyhedral at one wavelength value and stepwise varying this setting. For each setting, the merit function is determined. If the merit function is below a defined value, the corresponding setting is selected. Otherwise the iterative process is continued with further variations of the settings.

In further embodiments, the merit function represents a mean variation of a sum of the angles between the Stokes vectors over the wavelength range, a maximum variation of any angle between the Stokes vectors over the wavelength range, a mean variation of the line length over the wavelength range, if the number of states of polarization equals two, or a mean variation of the polyhedron volume over the wavelength range, if the number of states of polarization is greater than 3, or a maximum variation of the line length over the wavelength range, if the number of states of polarization equals two, or a maximum variation of the polyhedron volume over the wavelength range, if the number of states of polarization is greater than 3. It is apparent the merit functions listed above only serve as examples.

In further embodiment, the at least two adjustable optical components comprise a rotatable quarter-wave plate and a rotatable half-wave plate, that are adjusted according to the settings by rotating the wave plates.

In a further embodiment, the adjustable optical components comprise a plurality of wave plates, each of the wave plates having an individual tunable retardance. The wave plates are arranged with fixed relative angles with respect to their optical axes. The wave plates might be arranged to be rotated together or to be absolutely fixed. In order to control the polarization, the retardances of the wave plates are adjusted according to the settings (C1, C2).

The wave plates might be opto-electrical elements that change their retardances with respect to electric control signals. Therewith, the settings (C1, C2) might be embodied by corresponding electric signals, e.g. defined AC or DC currents or voltages.

In a further embodiment, three wave plates of variable retardance optically connected in series are comprised, wherein in idle or nominal state, the first wave plate and the third wave plate show half wave plate characteristics and the second wave in-between plate shows quarter wave plate characteristics.

With properly chosen wave plate settings, retardance errors of the wave plates over the wavelength ate converted into a slow rotation of the complete SOP-system, thus reducing the change of the shape spanned by the SOP vectors over wavelength, and thus enabling measurements over wide wavelength ranges with minimized errors As shape changes affect noise and sensitivity to measurement errors like detector PDL, the invention allows for minimizing such errors.

In a further embodiment, a rotatable polarizer is comprised, so that the rotatable quarter-wave plate and a rotatable half-wave plate might be adjusted to the settings by rotating the wave plates in relation to the polarization axis of the rotatable polarizer.

In a further embodiment selected ones of the following parameters might be entered by a user or might be selected from a set of proposed values by a user. Examples for such parameters are as follows: the wavelength range, the number of states of polarization, the geometric shape the merit function, and the desired value of the shape variation.

In a further embodiment, the invention allows for reducing the impact of retardance errors to measurement results even at single wavelength measurements.

Embodiments of the invention can be partly or entirely embodied or supported by one or more suitable software programs, which can be stored on or otherwise provided by any kind of data carrier, and which might be executed in or by any suitable data processing unit.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 shows a block diagram of a measurement setup for determining optical properties of a DUT, comprising a polarization controller according to the invention,

FIG. 2 shows a representation of a set of four exemplary tetragonal polarization states in a Poincaré sphere,

FIG. 3a shows angle variations over wavelength of angles between stokes vectors of an exemplary tetrahedral SOP system,

FIG. 3b shows a relative volume variation over wavelength of a tetrahedron defined by SOP system of 4 states, and

FIG. 4a-FIG. 4f shows equations related to exemplary merit functions.

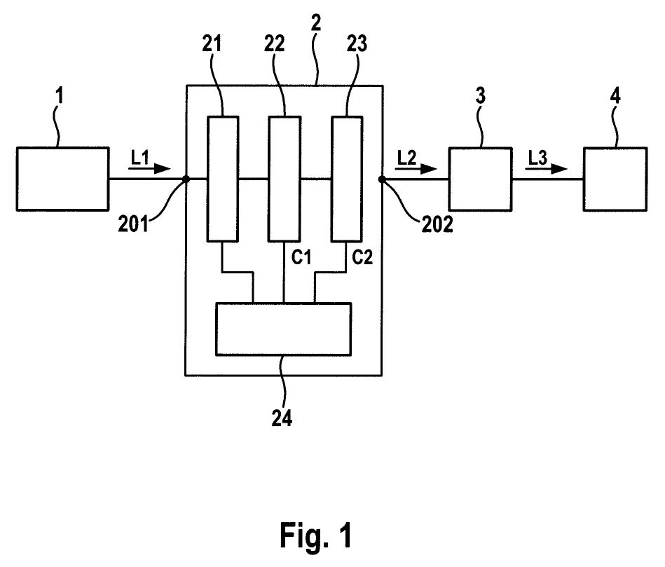

FIG. 1 shows a measurement setup for determining optical properties of an optical device under test (DUT) 3. A light source 1, preferably a tunable laser source, generates a first light signal L1. Said first light signal L1 is provided to a polarization controller 2, which generates a second light signal or probe signal L2 to be provided to the DUT 3, thereby transforming the input state into one of a set of different output states of polarization, e.g. of a set of four tetragonal polarization states. In response to the probe signal 2, the DUT emits a response signal L3. The response signal L3 might be a signal received through transmitting the through the DUT 3 or a reflected from the DUT 3. The DUT response signal L3 is provided to a detector 4, which determines the signal power of the response signal L3. For each one of the set of polarization states of the light signal L1, a corresponding signal power of the response signal L3 is obtained.

The relationship between the various polarization states on the one hand and the corresponding set of signal powers on the other hand allows getting a picture of the DUT's optical behavior. In case a tunable laser source is used as a light source 1, wavelength sweeps of the light signal 2 over a certain wavelength range might be performed. This allows recording the DUT's optical properties over the certain wavelength range.

The polarization controller 2 comprises a set of optical elements 21, 22, 23 that are positioned in series within the optical of the light signals L1 and L2. The optical elements are individually adjusted to create a desired polarization change between the input SOP of the first signal L1 to an output SOP of the second signal L2. In an embodiment, the polarization controller 2 comprises a quarter-wave plate 22 and a half-wave plate 23. These plates 22, 23 are also known as retardation plates or wave plates.

The quarter-wave plate 22 and the half-wave plate 23 are realized as being rotatable around a propagation axis of the incident light beam. The plates are each rotated by a determined angle to achieve a desired output state of polarization state. The rotation positions, e.g. relative to a polarization axis of the first light signal L1, can be denoted by angles α and β.

Retardation plates are optical elements with two principal axes, one slow axis and one fast axis that resolve an incident polarized beam into two mutually perpendicular polarized beams. Their operation is based on birefringent linear effect, which is the difference in the refractive indices for the beams with parallel and normal polarization towards the optical axis of the crystalline quartz material being within the wave plate plane. The emerging beam recombines to form a particular single polarized beam.

The thickness of a half wave plate is such that the phase difference is one half of the wavelength (zero-order wave plate) or defined multiples of one half of the wavelength (multi-order wave plates). A linearly polarized beam incident on a half wave plate emerges as a linearly polarized beam but rotates such that its angle to the optical axis is twice that of the incident beam. Therefore, half wave plates can be used as continuously adjustable polarization rotators.

The thickness of the quarter wave plate is such that the phase difference is one quarter of the wavelength (zero-order wave plate) or defined multiples of one quarter of the wavelength (multi-order wave plates). If the angle q between the electric field vector of an incident linearly polarized beam and the principal plane of the quarter wave plate is 45, the emergent beam is circularly polarized.

The above-described wave plates, especially the multi-order wave plates, are by their physical nature strongly dependent on the wavelength. Therefore so-called achromatic wave plates are available showing a reduced dependency from the wavelength in a certain range. Such achromatic wave plates might comprise double retardation plates of two different birefringent crystals. However, such wave plates are expensive and only how a reduced wavelength dependency, that might not be sufficient for high accuracy measurements.

The polarization controller 2 might further comprise an input polarizer 21 so that the retardation plates 22 and 23 are set relative to the input polarizer 21. The input polarizer might me additionally rotatable.

The polarization controller 2 further comprises a control unit 24 for determining the positions of the optical elements 21, 22, 23. Therefore the control unit 24 calculates control values C1-C2 to be provided to the optical elements to be set to the desired rotation angles.

The optical behavior of a DUT can be described by means of a Mueller matrix M, which is a 4×4 real matrix. Any equivalent matrix that represents the DUT's optical properties, e.g. a Jones matrix, can be used as well. The light signal incident upon the DUT can be described by a Stokes vectorSᵢₙ=(S0ᵢₙ,S1ᵢₙ,S2ᵢₙ,S3ᵢₙ), and the response signal obtained from the DUT can be described by a Stokes vectorSₒᵤₜ=(S0ₒᵤₜ,S1ₒᵤₜ,S2ₒᵤₜ,S3ₒᵤₜ). A Stokes vector S=(S0,S1,S2,S3) completely describes the power and polarization state of an optical wave, whereby S0 denotes the total intensity, S1 indicates the degree of linear horizontal (S1>0) or vertical polarization (S1<0), S2 indicates the degree of linear +45° (S2>0) or −45° (S2<0) polarization, and S3 corresponds to the degree of right-hand circular (S3>0) or left-hand circular (S3<0) polarization.

The interaction of an incident polarized wave characterized by the Stokes vector Sᵢₙ with the DUT can be expressed by means of the matrix equation:

Sₒᵤₜ=M·Sᵢₙ

This matrix equation represents four linear equations, but only the first one of said four equations is interesting for practical purposes. According to said first equation, the signal power S0ₒᵤₜ of a DUT response signal can be expressed as follows:

S0ₒᵤₜ=m₁₁·S0ᵢₙ+m₁₂·S1ᵢₙ+m₁₃·S2ᵢₙ+m₁₄·Sᵢₙ

In this equation, the Mueller matrix elements m₁ₖ, with k=1, 2, 3, 4, correspond to the first row of the Mueller matrix M. In order to determine the elements m₁₁, m₁₂, m₁₃, m₁₄ of the Mueller matrix, four different well-defined states of polarization S_{in,1},S_{in,2},S_{in,3},S_{in,4} are consecutively applied to the device under test, and the signal powers of the corresponding DUT response signals are measured.

Once the Mueller matrix elements m₁₁, m₁₂, m₁₃, m₁₄ are known, a multitude of optical properties of the DUT can be derived there from. For example, the Mueller matrix element m₁₁ indicates the “average loss” of the DUT. The minimum transmission Tₘᵢₙ and the maximum transmission Tₘₐₓ can be obtained as

Tₘᵢₙ=m₁₁−\sqrt{m₁₂²+m₁₃²+m₁₄²}

Tₘₐₓ=m₁₁+\sqrt{m₁₂²+m₁₃²+m₁₄²}

From these transmission extrema, the polarization dependent loss (PDL) can be determined as

$${PDL}_{dB} = 10 \cdot log ( \frac{{T}_{max}}{{T}_{min}} )$$

As soon as the first row of the Mueller matrix is known, any other optical property can be derived as well.

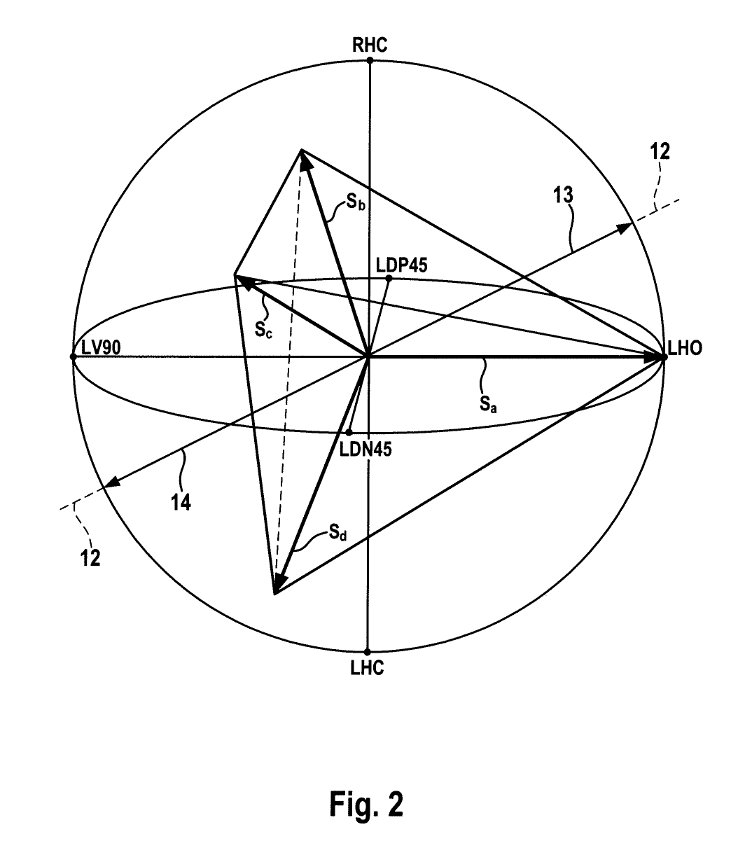

FIG. 2 shows a representation of a set of four exemplary tetragonal polarization states in a Poincaré sphere. The endpoints of the four Stokes vectors Sₐ, S_{b}, S_{c}, S_{d} define a regular tetrahedron, which is the most symmetric arrangement of four points on a sphere. The principal axis 12 of the DUT is shown, which is defined by the state of maximum transition 13 and the state of minimum transition 14. The principal axis 12 is arbitrarily oriented relative to the four states of polarization Sₐ, S_{b}, S_{c}, S_{d}. In the example shown in FIG. 2, the four states of polarization are defined as follows:

$${S}_{a} = ( 1 , 1 , 0 , 0 )$$

$${S}_{b} = ( 1 , - \frac{1}{3} , \sqrt{\frac{2}{3}} , \frac{\sqrt{2}}{3} )$$

$${S}_{c} = ( 1 , - \frac{1}{3} , - \sqrt{\frac{2}{3}} , \frac{\sqrt{2}}{3} )$$

$${S}_{d} = ( 1 , - \frac{1}{3} , 0 , \frac{- 2 \sqrt{2}}{3} )$$

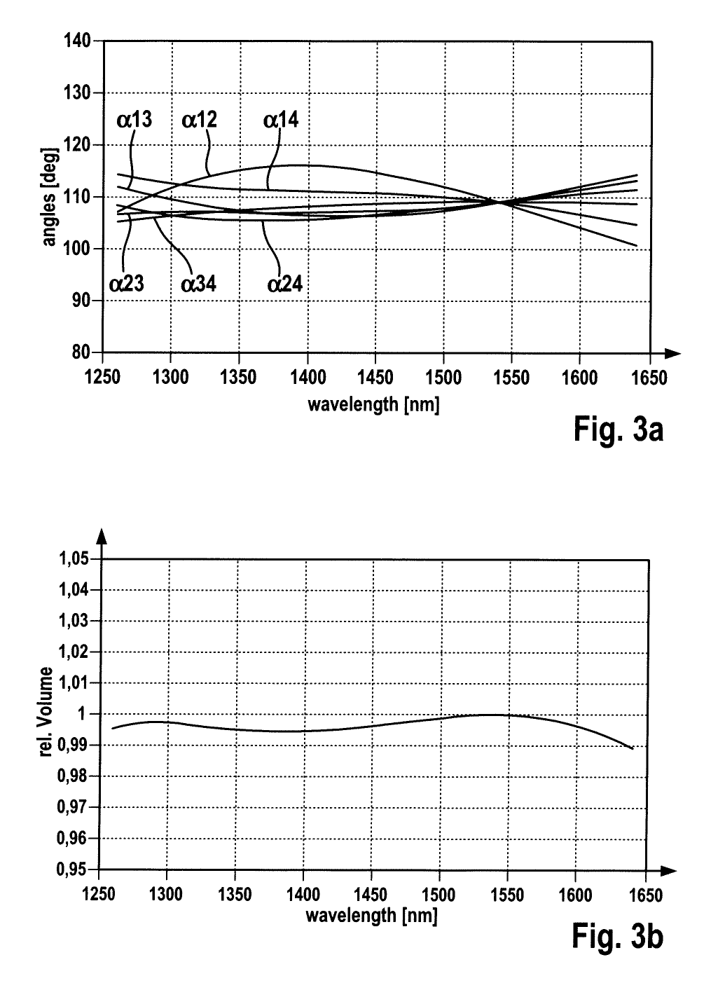

FIGS. 3a and 3b show angle of angles between stokes vectors of an exemplary tetrahedral SOP system and a corresponding relative volume variation over a wavelength range between 1250 nanometer and 1650 nanometer for a following exemplary pairs of settings of rotation angle α of the quarter wave plate 22 and rotation angle β of the half wave plate 23:

α={6.6,3.0,18.9,−54.45}

β={−1.0,−64.9,63.15,75.5}

FIG. 3a shows a diagram with the six relative angles α12, α13, α14, α23, α24, α34 between the four Stokes vectors Sₐ, S_{b}, S_{c} and S_{d}.

As can be seen from the diagram, the average variation of the angles is below 10 degree and even the maximum change of any angle (here: al 2) is below 20 degree.

FIG. 3b shows a diagram of a Volume of the tetrahedral compared to a nominal Volume. As can be seen from this drawing, the relative Volume change is in the range of 1 percent over the whole wavelength range. This change is far smaller in selected smaller wavelength ranges.

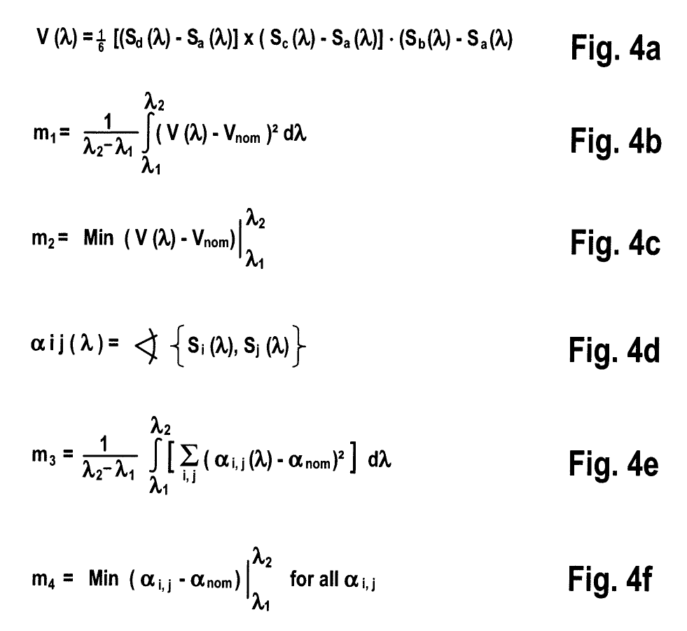

FIG. 4a-4f show equations related to exemplary merit functions.

FIG. 4a describes a volume over the wavelength of a tetrahedral.

FIG. 4b describes a first exemplary merit function ml defining a mean variation of the polyhedron volume over the wavelength range,

FIG. 4c describes a second exemplary merit function m2 defining a maximum variation of the polyhedron volume over the wavelength range,

FIG. 4d describes relative angles αij (α12, α13, α14, α23, α24, α34 for four states) between the Stokes vectors Sₐ, S_{b}, S_{c} and S_{d},

FIG. 4e describes a third exemplary merit function m3 defining a mean variation of a sum of the angles between the Stokes vectors over the wavelength range, and

FIG. 4f describes a fourth exemplary merit function m4 defining a maximum variation of any angle between the Stokes vectors over the wavelength range.

1. A method of for converting a first light signal into a second light signal polarized according to a set of different states of polarization, wherein the set of different polarization states is represented by a corresponding set of Stokes vectors in a Stokes space representation, and wherein the end points of the set of Stokes vectors span a geometric shape, comprising:
determining, in response to a desired geometric shape with an arbitrary orientation in the Stokes space, a setting of at least two adjustable optical elements arranged in an optical path between an optical input and an optical output such that, while varying the wavelength of the input signal within a certain range, corresponding variations of the geometric shape are below a desired value, and
adjusting the at least two optical elements of an arrangement of optical elements according to the determined setting.

2. The method of claim 1, wherein the geometric shape is a line if the number of states of polarization equals 2, a triangle if the number of states of polarization equals 3 and a polyhedron if the number of states of polarization is greater that 3.

3. The method of claim 1, further comprising:
defining a merit function representing the difference between the desired shape and the shape resulting from a setting over the wavelength range,
determining a plurality of settings,
selecting a setting out of the plurality of settings that shows a minimum merit function.

4. The method of claim 3, wherein the plurality of settings is determined by an iteration process by determining a first setting showing the desired shape at one wavelength value, varying this setting and determining the merit function for each variation until the merit function is below a certain value.

5. The method of claim 2, wherein the merit function describes one of:
a mean variation of a sum of the angles between the Stokes vectors over the wavelength range,
a maximum variation of any angle between the Stokes vectors over the wavelength range,
a mean variation of the line length over the wavelength range, if the number of states of polarization equals two, or a mean variation of the polyhedron volume over the wavelength range, if the number of states of polarization is greater than 3, and
a maximum variation of the line length over the wavelength range, if the number of states of polarization equals two, or a maximum variation of the polyhedron volume over the wavelength range, if the number of states of polarization is greater than 3.

6. The method of claim 5, wherein the number of output states of polarization equals 4, and wherein the settings are selected such that the mean variation of the corresponding tetrahedron volume over a wavelength range between 1250 nanometer and 1650 nanometer is below 1%.

7. The method of claim 1, wherein the at least two adjustable optical components comprise a rotatable quarter-wave plate and a rotatable half-wave plate, that are adjusted according to the settings by rotating the wave plates.

8. The method of claim 7, wherein the at least two adjustable optical components further comprise a rotatable polarizer, and wherein the rotatable quarter-wave plate and a rotatable half-wave plate are adjusted to the settings by rotating the wave plates in relation to the polarization axis of the rotatable polarizer.

9. The method of claim 1, wherein the at least two adjustable optical components comprise a plurality of wave plates each having an individual tunable retardance, the wave plates being arranged at fixed relative angles with respect to their optical axes, wherein their retardances are adjusted according to the settings.

10. The method of claim 9, wherein the wave plates are opto-electrical elements that change their retardances with respect to electric control signals, and wherein the control signals are generated according to the settings.

11. The method of claim 9, wherein the at least two adjustable optical components further comprise a rotatable polarizer, and wherein the retardances of the wave plates are adjusted according to the settings in relation to the polarization axis of the rotatable polarizer.

12. The method of claim 3, wherein at least one of the following parameters is received from a user interface:
the wavelength range,
the number of states of polarization,
the geometric shape
the merit function, and
the desired value of the shape variation.

13. An polarization controller for converting a first light signal into a second light signal polarized according to a set of different output states of polarization, wherein the set of different polarization states is represented by a corresponding set of Stokes vectors in a Stokes space representation, and the end points of the set of Stokes vectors span a geometric shape, comprising:
an optical input adapted for receiving the first light signal having an input state of polarization,
an optical output adapted for emitting the second light signal having one of the states of the set of different output states of polarization,
an arrangement of optical elements positioned in an optical path between the optical input and the optical output, whereof at least two of the optical elements are adjustable, and
a control unit adapted to determine, in response to a desired geometric shape with an arbitrary orientation in the Stokes space, settings of the at least two adjustable optical elements such that, while varying the wavelength of the input signal within a certain range, corresponding variations of the geometric shape are below a desired value.

14. A software program or product, embodied on a computer readable medium, for controlling or executing the method of claim 1, when run on a data processing system of a polarization controller.
